(19) United States
(12) Patent Application Publication
(10) Pub. No.: US 2005/0270133 A1
(43) Pub. Date: Dec. 8, 2005

(54) Transformer structure

(76) Inventors: Chun-Kong Chan, Hsi Chih City (TW); Jeng-Shong Wang, Hsin Chuang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/862,386

(22) Filed: Jun. 8, 2004

(51) Int. Cl. H01F 27/24

(52) U.S. Cl. 336/83

(57) ABSTRACT

An improved transformer structure has a low-voltage side coil, two high-voltage side coils, two E-shaped magnetic cores and a C-shaped magnetic core. The two E-shaped magnetic cores and the C-shaped magnetic core are assembled with the low-voltage side coil and the two high-voltage side coils, respectively. Through the C-shaped magnetic core, when a short circuit occurs in the high-voltage side coil of the transformer, power conversion of the low-voltage side coil is not affected, hence accomplishing short-circuit protection of the transformer. Moreover, the counter magnetomotive force generated at the low-voltage side coil of the transformer can be reduced through the C-shaped magnetic core, hence protecting the low-voltage side coil and also decreasing heat generated by the transformer.

### FIELD OF THE INVENTION

The present invention relates to an improved transformer structure and, more particularly, to a structure capable of avoiding influence upon the low-voltage side coil of a transformer when a short circuit occurs in the high-voltage side coil of the transformer.

### BACKGROUND OF THE INVENTION

As shown in FIG. 1, a primary side coil 61 and a secondary side coil 62 of a transformer 60 are wound around a first side column 63 and a second side column 64, respectively.

When the primary side coil 61 accepts an induction power source, a magnetic flux will be produced at the first side column 63 and flow to the second side column 64 and then flow back to the first side column 63. The magnetic flux can thus be coupled to the secondary side coil 62 to produce an induced voltage for driving a load connected therewith.

Because the primary side coil 61 and the secondary side coil 62 of the transformer 60 are wound around the first side column 63 and the second side column 64 of the transformer 60, the two coils 61 and 62 share the same magnetic circuit to increase the mutual inductance thereof. When the transformer 60 drives a load, a very large load current will be produced on the primary side coil 62. This load current will induce a very large counter magnetomotive force to affect power conversion of the primary side coil 61 and generate large heat on the primary side coil 61. If a short circuit occurs in the secondary side coil 62 for some reason, the power source of the primary side coil 61 will be affected.

### SUMMARY OF THE INVENTION

Accordingly, one object of the present invention is to propose a structure capable of avoiding influence upon power conversion of the low-voltage side coil of a transformer when a short circuit occurs in the high-voltage side coil of the transformer, hence accomplishing short-circuit protection of the transformer.

To achieve the above object, the present invention proposes an improved transformer structure, comprising a transformer and a magnetic component. The transformer is formed by assembling two E-shaped magnetic cores and a low-voltage side coil and two high-voltage side coils, respectively. The magnetic component is connected at positions where the magnetic cores and the low-voltage side coil and the high-voltage side coils are connected together.

The above low-voltage side coil and high-voltage side coils are formed by winding a copper wire around a hollow tube-shaped winding frame, respectively.

The above magnetic component is a C-shaped magnetic core.

### BRIEF DESCRIPTION OF THE DRAWINGS

The various objects and advantages of the present invention will be more readily understood from the following detailed description when read in conjunction with the appended drawing, in which:

FIG. 1 is a perspective view of a conventional transformer structure;

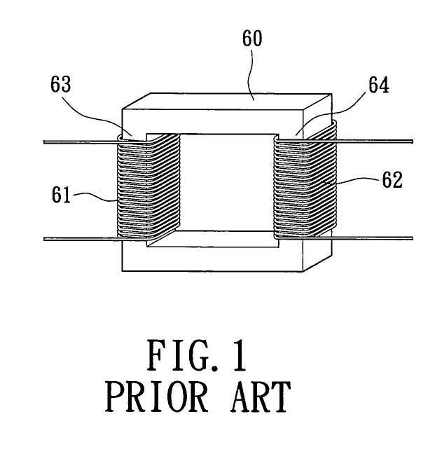

FIG. 2 is a perspective view of the present invention;

FIG. 3 is an exploded view of the present invention; and

FIG. 4 is a diagram according to an embodiment of the present invention.

### DETAILED DESCRIPTION OF THE PREFERRED EMBODIMENTS

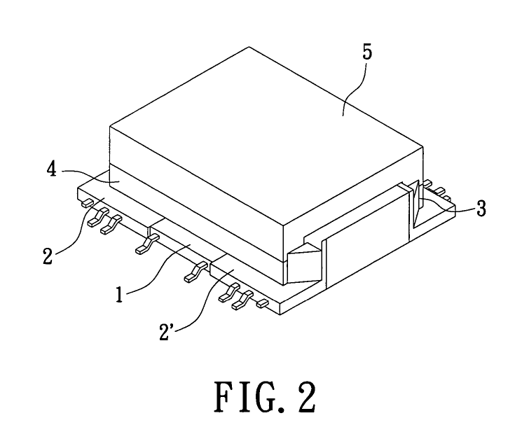

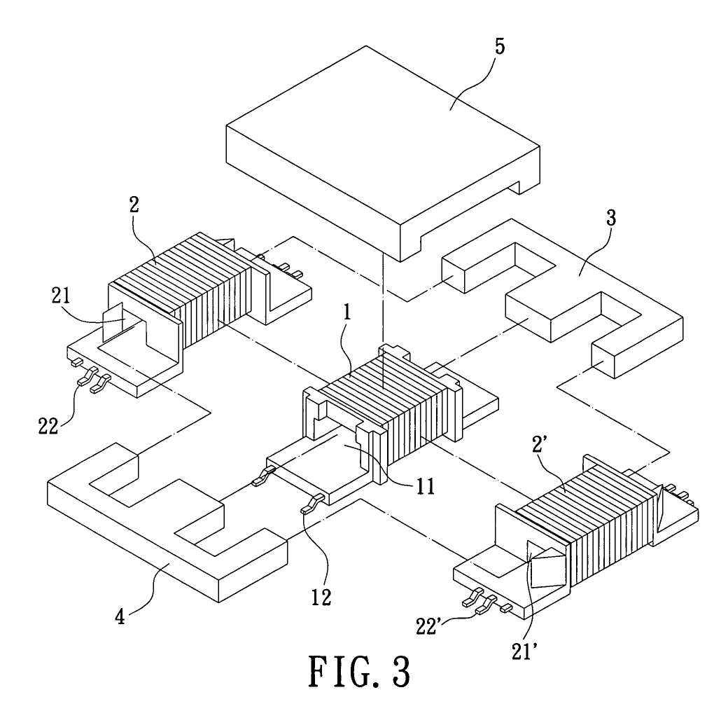

As shown in FIGS. 2 and 3, a modified transformer structure of the present invention comprises a low-voltage side coil 1, two high-voltage side coil 2 and 2′, a first E-shaped magnetic core 3, a second E-shaped magnetic core 4 and a C-shaped magnetic core 5. Each of the high-voltage side coils 2 and 2′ is formed by winding a copper wire around a hollow tube-shaped winding frame. An axial hole 21 (21 ′) is provided in the winding frame. A plurality of pins 22 (22′) for electric connection is connected at the outer edge of the winding frame.

The low-voltage side coil 1 is located between the two high-voltage side coils 2 and 2′. The low-voltage side coil 1 is formed by winding a copper wire around a hollow tube-shaped winding frame. An axial hole 11 is provided on the winding frame. A plurality of pins 12 for electric connection is connected at the outer edge of the winding frame.

The open end of the first E-shaped magnetic core 3 is connected with the axial holes 11 and 21 and 21′ at one side of the low-voltage side coil 1 and the high-voltage side coils 2 and 2′.

The open end of the second E-shaped magnetic core 4 is connected with the axial holes 11 and 21 and 21′ at the other side of the low-voltage side coil 1 and the high-voltage side coils 2 and 2′.

The C-shaped magnetic core 5 is connected at positions where the magnetic cores 3 and 4 and the low-voltage side coil 1 and the high-voltage side coils 2 and 2′ are connected together.

The low-voltage side coil 1 and the two high-voltage side coils 2 and 2′ can thus be isolated to have no mutual inductance therebetween and cause high leakage inductance at the high-voltage side coils 2 and 2′. Moreover, the high-Q value of the resonance cavities of the high-voltage side coils 2 and 2′ is used to form a high-voltage transformer with a low number of turns.

When the low-voltage side coil 1 accepts an induction power source, a magnetic flux will be produced on the side column of the first E-shaped magnetic core 3 and flow to the C-shaped magnetic core 5 and the side column of the second E-shaped magnetic core 4 along the magnetic circuit in the magnetic core 3 and then flow back to the side column of the first E-shaped magnetic core 3. The magnetic flux can thus be coupled to the high-voltage side coils 2 and 2′ to produce an induced voltage across two ends of the high-voltage side coils 2 and 2′ for driving a load.

Reference is made again to FIG. 2. When the transformer is used to drive a load, a load current will flow in the high-voltage side coils 2 and 2′. This load current will produce a counter magnetic flux in the side column. Due to the magnetic flux on the side column of the low-voltage side coil 1, this counter magnetic flux will flow to the C-shaped magnetic core 5 and then flow back to the side column of the high-voltage side coils 2 and 2′. Therefore, this counter magnetic flux does not produce a counter magnetomotive force on the low-voltage side coil 1, and hence does not influence power conversion of the low-voltage side coil 1. Moreover, when the transformer is used to drive a load, the working temperature of the transformer does not rise due to increase of the load.

When a short circuit occurs in the high-voltage side coil 2 (2′) of the transformer for some reason, a very large short-circuit current will instantaneously be produced in the high-voltage side coil 2 (2′). This short-circuit current will produce a very large counter magnetic flux in the side column of the high-voltage side coil 2 (2′). Because of the magnetic flux on the side column of the low-voltage side coil 1, this counter magnetic flux will flow to the C-shaped magnetic core 5 and then flow back to the side column of the high-voltage side coil 2 (2′). Therefore, this counter magnetic flux does not produce a very large counter magnetomotive force on the low-voltage side coil 1. Burnout of the low-voltage side coil 1 does not occur and power conversion of the low-voltage side coil 1 is not affected, hence accomplishing short-circuit protection of the transformer.

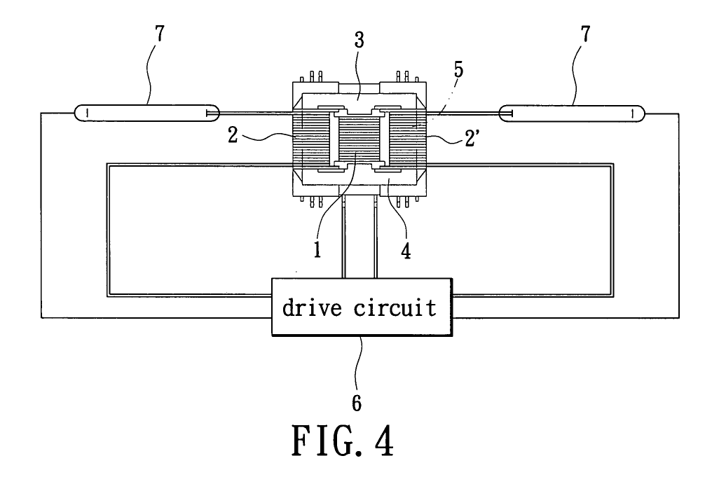

As shown in FIG. 4, a drive circuit 6 is connected with the low-voltage side coil 1, and a cold cathode fluorescent lamp (CCFL) 7 is connected with the high-voltage side coils 2 and 2′.

When the low-voltage side coil 1 accepts an induction power source from the drive circuit 6, a magnetic flux will be produced on the side column of the low-voltage side coil 1, flow to the side column of the high-voltage side coils 2 and 2′ and then flow back to the side column of the low-voltage side coil 1. The magnetic flux can thus be coupled to the high-voltage side coils 2 and 2′ to produce an induced voltage for driving the CCFL 7 to be on.

Because the inductance of the high-voltage side coils of the transformer in the above circuit can be used as a current-stabilizing coil of CCFL, and the above circuit have the characteristics of high leakage inductance and high-Q value, it is very suitable for driving U-shaped and M-shaped CCFLs.

To sum up, in the present invention, two E-shaped magnetic cores and a C-shaped magnetic core are assembled with a low-voltage side coil and two high-voltage side coils, respectively. Using the C-shaped magnetic core to close the magnetic circuit, when a short circuit occurs in the high-voltage side coils of the transformer for some reason, power conversion of the low-voltage side coil is not affected, hence accomplishing short-circuit protection of the transformer.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. An improved transformer structure, comprising:
a E-shaped magnetic core and a second E-shaped magnetic core disposed in contiguous and facing relationship to define a central column and a pair of laterally spaced side columns, each of said first and second E-shaped magnetic cores having a laterally extending leg interconnecting respective end portions of said central column and said pair of laterally spaced side columns;
a low-voltage coil wound around said central column;
two high-voltage coils respectively wound around said pair of laterally spaced side columns; and
a C-shaped magnetic core overlaying said low-voltage coil and said two high-voltage coils with opposing ends thereof being respectively contiguous said laterally extending leg portions of said first and second E-shaped magnetic cores.

2-3. (canceled)

4. An improved transformer structure, comprising:
a first high-voltage coil wound around a first hollow tube-shaped winding frame, said first hollow tube-shaped winding frame having a first axial hole formed therethrough;
a second high-voltage coil wound around a second hollow tube-shaped winding frame, said second hollow tube-shaped winding frame having a second axial hole formed therethrough;
a low-voltage coil wound around a third hollow tube-shaped winding frame, said third hollow tube-shaped winding frame having a third axial hole formed therethrough;
a pair of E-shaped magnetic cores each having three longitudinally extended legs respectively inserted into said first, second and third axial holes from opposing ends thereof, each of said pair of E-shaped magnetic cores having a laterally extending leg connecting said three longitudinally extended legs thereof, said low-voltage coil being disposed between said first and second high-voltage coils; and
a C-shaped magnetic core overlaying said low-voltage coil and said first and second high-voltage coils with opposing ends thereof being respectively contiguous said laterally extending legs of said pair of E-shaped magnetic cores.

5. (canceled)
